(19) United States
(12) Patent Application Publication
(10) Pub. No.: US 2010/0300351 A1
(43) Pub. Date: Dec. 2, 2010

(54) APPARATUS FOR PRODUCTION OF COMPOSITE MATERIAL SHEET

(75) Inventors: Yoshinari Yasui, Kanagawa (JP); Takashi Iwasaki, Kanagawa (JP)

Correspondence Address: Quinn Emanuel Urquhart & Sullivan, LLP, 865 S. FIGUEROA STREET, 10TH FLOOR, LOS ANGELES, CA, 90017, US

(73) Assignee: YASUI SEIKI CO., LTD.

(21) Appl. No.: 12/735,591

(22) PCT Filed: Dec. 24, 2008
(86) PCT No.: PCT/JP2008/073470

§ 371 Date: Jul. 30, 2010

(30) Foreign Application Priority Data
Feb. 29, 2008 (JP) 2008-050030

(51) Int. Cl. B05C 9/14

(52) U.S. Cl. 118/58

(57) ABSTRACT

An apparatus for production of a composite material sheet is provided that can achieve a thinner composite material sheet, effectively prevent occurrence of curling, perform continuous production, and produce a high-quality composite material sheet having excellent heat resistance, weather resistance, flexibility, shape retention, peel strength, and the like.

The apparatus includes: a pre-heating means 12 that dries by heating a base material 2 coated with an organic solution and conveyed in a length direction until 10% to 15% of a solvent within an organic solvent remains; a curing oven 13 into which and from which the base material 2 coated with the organic solution that is pre-heated by the pre-heating means 12 is freely conveyed in a length direction of the base material 2; an inert gas supplying means 18 for holding the base material 2 coated with the organic solution immediately before being conveyed into the curing oven 13 within an inert gas atmosphere in the pre-heating means 12 and preventing oxidation of the base material 2; a roll 21 that winds a surface of the base material 2 not coated with the organic solution to be dried and carries the base material 2 into the curing oven 13, and heats the base material 2 and the organic solution; an inert gas supplying means 23 and 24 for forming an inert gas film between the roll 21 and the base material 2, and maintaining the interior of the curing oven 13 at a low oxygen concentration preventing oxidation of the base material 2; and a heating means 22 for heating the organic solution applied to the base material 2 wound around the roll 21 to a temperature that is a glass transition point of a resin 3 or higher and reducing a residual amount of solvent within the organic solvent to 1% or less (preferably 0.5%).

### TECHNICAL FIELD

The present invention relates to an apparatus for production of a composite material sheet. In particular, the present invention relates to an apparatus for production of a composite material sheet including a resin thin-film layer formed by an organic solvent being cured on a base material.

### BACKGROUND ART

A composite material sheet including a resin thin-film layer on a base material has been used in various fields since the past.

For example, a composite material sheet in which a copper foil that is a type of metal thin film serves as the base material is used as a flexible printed board. A composite material sheet in which a stainless steel (SUS) foil serves as the base material is used as a spring member in a hard disk drive (HDD). A composite material sheet in which nickel silver serves as the base material is used as an insulation shield. A composite material sheet in which polyethylene terephthalate (PET) (polyester film), polyethylene naphthalate (PEN), polyester (PES), butyral, nylon, or the like serves as the base material is used as a heat-resistant film or a coverlay film for electronics.

To produce a composite material film used in a wide range of fields, such as that described above, an elongated base material is conveyed to a coating position by a conveying means, such as a roller. At the coating position, an organic solvent is applied to the base material by use of a coating method, such as die coating or gravure coating. The organic solvent is then cured by the organic solvent being dried and a solvent within the organic solvent being removed. As a result, a composite material sheet can be produced in which a resin thin-film layer is formed by the organic solvent being cured on the base material.

### Patent Literature 1: Japanese Patent Laid-open Publication No. 2001-179919

### DISCLOSURE OF INVENTION

### Problem to be Solved by the Invention

However, conventionally, when forming the composite material sheet, when the resin thin-film layer is formed on the base material by the organic solvent applied to the base material being dried and cured, both end edges of the composite material sheet in a width direction curl towards the resin thin-film layer side. Occurrence of a phenomenon referred to as curling in which the overall film becomes curved becomes a problem.

In particular, compactness and complexity of mobile phones, liquid crystal televisions, and other electronic devices of recent years have advanced. Regarding the flexible printed board used in such devices that is made of a composite material sheet in which a copper foil serves as the base material, in addition to achieving a thinner film, excellent heat resistance, weather resistance, flexibility, shape retention, peel strength, and the like are required. However, no flexible printed board meets these requirements.

More specifically, the resin applied to the copper foil is a polyimide resin. The polyimide resin is formed using an amic acid solution that is a precursor of resin as a coating ingredient. The amic acid solution is reacted while being cured (hardened) such as to remove an N-methylpyrrolidone (NMP) solvent within the solution during drying. Therefore, shrinkage caused by the reaction is significantly greater compared to that in other resins, and curling occurs more easily.

In addition, the polyimide resin is a resin in which evaporation of the NMP solvent from the organic solvent is difficult. This is also considered to be a reason curling tends to easily occur in the polyimide resin.

Unless almost 100% of the NMP solvent is removed, the NMP solvent within the polyimide resin evaporates when the composite material sheet is heated to 250° C. or higher when wires are connected by soldering during wiring. The copper foil and the polyimide separate, and peel strength is significantly weakened. In the worst case, a problem occurs in that the copper foil and the polyimide separate.

Therefore, conventionally, after the copper foil is coated with the amic acid solution, the coated material is wound around a stainless meshed sheet. The wound material is placed in an oven in a nitrogen atmosphere and heated. However, the NMP solvent is not removed until the material is placed at 500° C. to 700° C. for 48 hours. A problem occurs in that the process is impractical for a product. Furthermore, because tracks from the stainless meshing remain on the copper foil as projections and recesses, problems may occur in terms of use as a product. In particular, air may enter the tracks during multi-layering. The composite material sheet is unsuitable for a multi-layer flexible board.

Therefore, conventionally, continuous production of a high-quality composite material sheet while conveying the composite material sheet has been desired.

The present invention has been achieved in light of the above-described issues. An object of the present invention is to provide an apparatus for production of a composite material sheet in which a composite material sheet can be made thinner, occurrence of curling can be effectively prevented, continuous production can be performed, and a high-quality composite material sheet having excellent heat resistance, weather resistance, flexibility, shape retention, peel strength, and the like can be produced.

### Means for Solving Problem

To achieve the above-described object, an apparatus for production of a composite material sheet according to a first aspect of the present invention is an apparatus for production of a composite material sheet including a resin thin-film layer formed by an organic solvent being cured on a base material by an organic solution composed of the organic solvent and a solvent being applied to a continuous base material, and the organic solution on the base material being dried and cured at a predetermined atmospheric temperature. The apparatus includes: a pre-heating means for drying by heating the base material coated with the organic solution and conveyed in a length direction until 10% to 15% of the solvent within the organic solvent remains; a curing oven into which and from which the base material coated with the organic solution that is pre-heated by the pre-heating means is freely conveyed in a length direction of the base material; an inert; gas supplying means for holding the base material coated with the organic solution immediately before being conveyed into the curing oven within an inert gas atmosphere in the pre-heating means and preventing oxidation of the base material; a roll that winds a surface of the base material not coated with the organic solution to be dried and carries the base material into the curing oven, and heats the base material and the organic solution; an inert gas supplying means for forming an inert gas film between the roll and the base material, and maintaining the interior of the curing oven at a low oxygen concentration preventing oxidation of the base material; and a heating means for heating the organic solution applied to the base material wound around the roll to a temperature that is a glass transition point of the resin or higher and reducing a residual amount of solvent within the organic solvent to 1% or less (preferably 0.5%).

In an apparatus such as that described above, the base material coated with the organic solution is dried by heating by the pre-heating means until 10% to 15% of the solvent within the organic solvent remains. The base material is held within an inert gas atmosphere formed by the inert gas supplying means in a section immediately before the base material is conveyed into the curing oven, and oxidation of the base material is prevented. The base material coated with the organic solution and conveyed into the curing oven from the pre-heating means in this state is conveyed with an inert gas film interposed between a surface not coated with the organic solution to be dried and an outer peripheral surface of the roll that is in a heated state. While the base material is being conveyed, the base material passes through a low oxygen concentration atmosphere within the curing oven that prevents oxidation of the base material. Therefore, oxidation is prevented. At the same time, the organic solvent is heated to the glass transition point of the resin or higher by heat applied by the roll and the heating means. The solvent is sufficiently removed such that the residual amount is 1% or less (preferably 0.5% or less), and the organic solvent is cured. As a result, a high-quality, thin-film composite material sheet having no curling and having excellent heat resistance, weather resistance, flexibility, shape retention, peel strength, and the like is continuously produced.

A second aspect of the apparatus for production of a composite material sheet of the present invention is that according to the first aspect in which the base material is a copper thin film, the resin is a polyimide resin, the inert gas is nitrogen gas, oxygen concentration in the inert gas supplying means section of the preheating means is 500 PPM to 1000 PPM, and the oxygen concentration within the curing oven is 100 PPM to 500 PPM.

In an apparatus such as that described above, when a base material made of a copper thin film, such as a copper foil, is used, oxidation of copper that is the base material can be effectively prevented by nitrogen gas. In addition, the included solvent can be almost completely removed and the polyimide resin can be cured. A high-quality composite material sheet can be achieved.

### EFFECT OF THE INVENTION

As a result of the apparatus for production of a composite material sheet of the present invention, excellent effects can be achieved, such as achieving a thinner composite material sheet, effectively preventing the occurrence of curling, performing continuous production, and producing a high-quality composite material sheet having excellent heat resistance, weather resistance, flexibility, shape retention, peel strength, and the like.

### BRIEF DESCRIPTION OF DRAWINGS

FIG. 1 is a schematic front view of an apparatus for production of a composite material sheet according to an embodiment of the present invention.

FIG. 2 is a schematic cross-sectional view of a curing oven according to the embodiment of the present invention.

FIG. 3 is a side view of a composite material sheet of the present invention.

### EXPLANATIONS OF LETTERS OR NUMERALS

### Best Mode(s) for Carrying Out the Invention

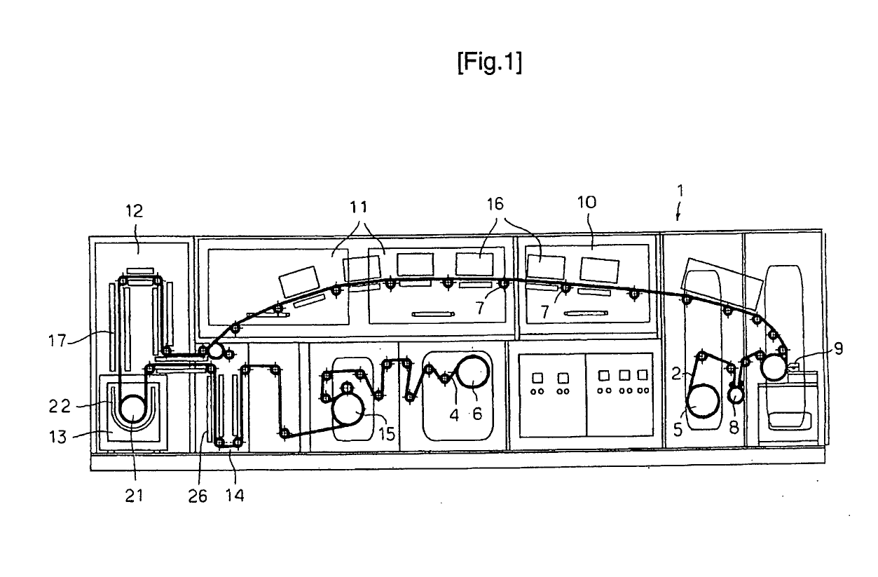

Next, an apparatus for production of a composite material sheet of the present invention will be described with reference to FIG. 1 to FIG. 3.

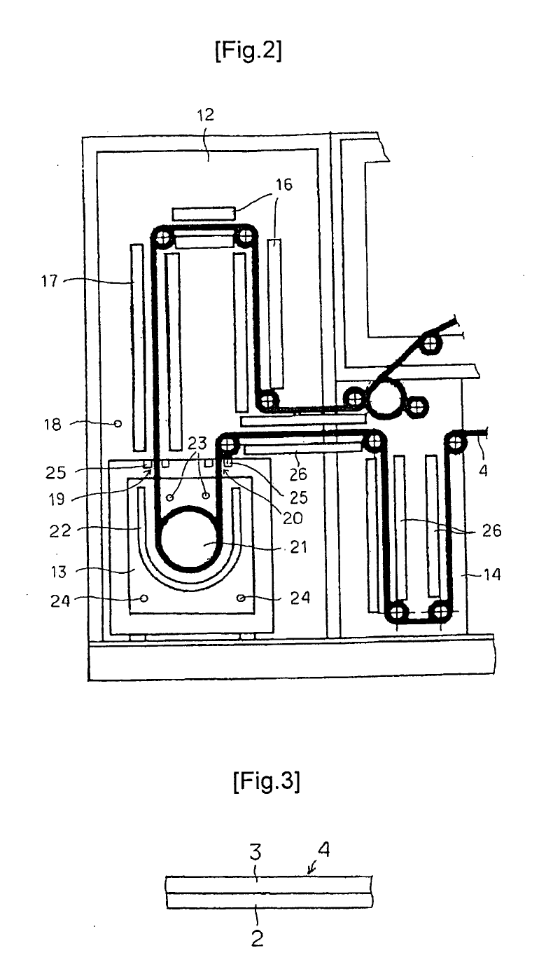

FIG. 1 and FIG. 2 are diagrams of an apparatus for production of a composite material sheet according to an embodiment of the present invention.

An apparatus for production 1 according to the embodiment will be described giving as an example when a composite material sheet 4 is produced in which a polyimide resin 3 is laminated on a base material 2 made of a copper thin film, such as a copper foil, as shown in FIG. 3.

The apparatus for production 1 shown in FIG. 1 and FIG. 2 has a conveying path for the base material 2 that reaches from a raw-material roll 5 of the base material 2 to a winding device 6. A plurality of guide rollers 7 that hold the conveyance of the base material 2 are disposed over the serial conveying path. A feed-out device 8 that feeds out the elongated base material 2 wound around the raw-material roll 5 is provided downstream from the raw-material roll 5. A coating device 9 that applies an amic acid solution (a mixture of an organic solvent and a solvent), serving as a precursor of polyimide resin, to the front surface of the base material 2 fed out from the feed-out device 8 is provided downstream from the feed-out device 8. A die coater, a reverse coater, a knife coater, or a micro-gravure coater having a gravure roll with a diameter of 50 millimeters or less can be disposed as the coating device 9. The polyimide resin has a high water-absorption rate. When air is caught therein, changes in viscosity or cloudiness occur. As a result, polyimide characteristics after coating are likely to be lost. Therefore, according to the embodiment, the die coater that prevents contact with air is used. A plurality of drying ovens 10, 11, and 12 are provided in a row downstream from the coating device 9. The drying ovens 10, 11, and 12 serve as a pre-heating means for performing heated-air drying until 10% to 15% of the solvent within the organic solvent remains on the base material 2. A curing oven 13 that finally cures the organic solvent and forms the polyimide resin 3 is provided downstream from the drying ovens 10, 11, and 12. A gradual-cooling device 14 that gradually cools the composite material sheet 4 that is at a high temperature is provided downstream from the curing oven 13. A winding driving device 15 that drives to wind the cooled composite material sheet 4 is disposed between the gradual-cooling device 14 and the winding device 6.

In the two upper-stream drying ovens 10 and 11 among the plurality of drying ovens 10, 11, and 12 serving as the pre-heating means, a plurality of heaters 16 that emit infrared rays or far-infrared rays are disposed facing the organic solution. The drying ovens 10 and 11 are formed such as to gradually heat the base material 2 coated with the organic solution to about 150° C. In the drying oven 12 disposed downstream from the drying ovens 10 and 11, a plurality of heaters 17 that emit infrared rays or far-infrared rays are disposed on a side facing the organic solution and, when required, a side facing the base material 2. The drying oven 12 is formed such as to finally gradually heat the base material 2 coated with the organic solution to about 300° C. to 350° C., and dry by heating the organic solution until 10% to 15% of the solvent within the organic solvent remains. Furthermore, regarding the base material 2 coated with the organic solution immediately before being conveyed to the curing oven 13, the heaters 17 are disposed on both the side facing the organic solution and the side facing the base material 2. In addition, a nitrogen gas nozzle 18 is disposed as an inert gas supplying means for supplying nitrogen gas serving as an inert gas between both heaters 17 and forming an inert gas atmosphere having an oxygen concentration of 500 PPM to 1000 PPM. As a result, the base material 2 is held within an inert gas atmosphere within the drying oven 12 immediately before being conveyed to the curing oven 13, and oxidation is prevented.

On the top surface of the curing oven 13 disposed downstream from the drying oven 12, an entrance 19 and an exit 20 are formed from which the composite material sheet 4 is freely conveyed into and out of the curing oven 13 in the length direction. A roll 12 is suspended across the center within the curing oven 13 such as to rotate freely. The roll 12 has a diameter of 200 millimeters to 1000 millimeters and conveys the composite material sheet 4 such that the surface of the base material 2 not coated with the organic solvent to be dried is wound. The roll 21 is formed such as to freely switch between free rotation and driven-rotation. The roll 21 is freely rotated when unnecessary tension is prevented from being applied to the base material 2. A low-temperature heater (not shown) is installed within the roll 21 to hold the base material 2 at a temperature lower than the glass transition point (about 350° C.) of the polyimide resin 3. A heating heater 22 that emits infrared rays or far-infrared rays is disposed in an arc-shaped position facing the organic solvent to serve as a heating means for heating the organic solvent to a temperature that is the glass transition point or higher (such as 380° C. to 420° C.) to polyimidize the organic solvent. The heating heater 22 emits infrared rays or far-infrared rays. As a result of receiving heat from the heating heater 22 and the heater within the roll 21, the residual amount of the solvent within the organic solvent applied to the base material 2 becomes 1% or less (preferably 0.5% or less), forming a high-quality polyimide resin. Furthermore, a film-forming nitrogen gas nozzle 23 is disposed that sprays nitrogen gas that is a type of inert gas towards the upper outer peripheral surface of the roll 21 to form an inert gas film between the roll 21 and the base material 2 of the composite material sheet 4. To ensure formation of the inert gas film, the outer peripheral surface of the roll 21 can be roughened, and a matte finishing formed by fine projections and recesses can be applied. At least one nitrogen gas nozzle 24 is disposed that supplies a required amount of nitrogen gas that is a type of inert gas to lower oxygen concentration (such as to 100 PPM to 500 PPM) within the curing oven 13. The film-formation nitrogen gas nozzle 23 and the nitrogen gas nozzle 24 form an inert gas supplying means for preventing significant oxidation of the copper thin film serving as the base material 2 by forming the inert gas film between the roll 21 and the base material 2 and maintaining low oxygen concentration within the curing oven 13. To maintain low oxygen concentration within the curing oven 13, curtain nitrogen gas nozzles 25 can be disposed to form nitrogen gas curtains in the entrance 19 and the exit 20.

In the gradual-cooling device 14 disposed downstream from the curing oven 13, a plurality of heaters 26 that emit infrared rays or far-infrared rays are disposed on the side facing the polyimide resin 3 and, when required, the side facing the base material 2 to gradually cool the composite material sheet 4 that is at a high temperature to a normal temperature. Stability of crystallization of the copper in the base material 2 is achieved. Flatness of the polyimide resin 3 and the base material 2 is maintained.

Next, effects according to the present embodiment will be described.

First, after the base material 2 is conveyed from the raw-material roll 5 to the coating device 9 section by way of the feed-out device 8, the amic acid solution serving as a precursor of the organic solvent polyimide resin is applied to the base material 2. In this instance, the thickness of the base material 2 of the composite material sheet 4 is about 9 micrometers and the thickness of the polyimide resin 3 is about 10 micrometers in a finished state.

Then, after the organic solvent is applied to the base material 2, the base material 2 is conveyed into the plurality of drying ovens 10, 11, and 12, serving as the pre-heating means. Within each drying oven 10, 11, and 12, the organic solvent on the base material 2 is dried at a predetermined atmospheric temperature, thereby prompting curing of the organic solvent. At this time, drying can be efficiently performed by hot air being blown over the front surface of the organic solvent by an air blower, such as a blower. According to the present embodiment, in the two upper-stream side drying ovens 10 and 11 of the pre-heating means, the base material 2 coated with the organic solution is gradually heated to about 150° C. Then, in the drying oven 12 disposed further downstream from the drying ovens 10 and 11, the plurality of heaters 17 finally gradually heat the base material 2 coated with the organic solution to about 300° C. to 350° C., and dried by heating until 10% to 15% of the solvent within the organic solvent remains. Furthermore, regarding the base material 2 coated with the organic solution immediately before being conveyed to the curing oven 13, nitrogen gas serving as an inert gas is supplied from the nitrogen gas nozzle 18 between both heaters 17 disposed on the side facing the organic solution and the side facing the base material 2. An inert gas atmosphere with an oxygen concentration of 500 PPm to 1000 PPM is formed. Therefore, the copper in the base material 2 heated to a high temperature by both heaters 17 is effectively prevented from oxidizing.

The copper thin film of the base material 2 and the organic solvent that are gradually heated to about 300° C. to 350° C. upstream from the curing oven 13 are conveyed into the curing oven 13, passing successively through the approximately 300° C. nitrogen gas curtain formed by the curtain nitrogen gas nozzle 25 and the entrance 19. The copper thin film of the base material 2 can have a slightly roughened surface to enhance bonding with the polyimide resin 3.

The interior of the curing oven 13 is maintained at a low oxygen concentration of 100 PPm to 500 PPM by the approximately 300° C. nitrogen gas supplied by the nitrogen gas nozzle 24. When the surface of the base material 2 coated with the polyimide resin 3 to be dried and the opposite-side surface before curing are wound around the roll 21 that is in the free-rotation state, the approximately 300° C. nitrogen gas sprayed from the film-forming nitrogen gas nozzle 23 is held such as to be caught along the outer peripheral surface of the roll 21, specifically by the matte section formed on the outer peripheral surface. Therefore, a nitrogen gas thin film is formed between the base material 2 and the outer peripheral surface of the roll 21. Then, in this state, the base material 2 is held at a temperature that is the glass transition point of the polyimide resin 3 or lower, as a result of the base material 2 being wound around the roll 21 held at a temperature lower than the glass transition point. As a result, the copper thin film that serves as the base material 2 is not affected by an oxidation effect and is not excessively heated.

At the same time, the polyimide resin 3 applied to the outer side of the base material 2 is heated by the heating heater 22 to a temperature that is the glass transition point (350° C.) of the polyimide resin 3 or higher, namely 380° C. to 420° C. Almost 100% of NMP that is the included solvent is removed (the residual amount of NMP is 1% or less [preferably 0.5% or less]). As a result, polyimidization is ensured. Furthermore, the slight amount of oxygen within the curing oven 13 penetrates the cured polyimide resin 3 in the thickness direction and reaches the copper thin film of the base material 2. The copper is slightly oxidize, further strengthening bonding with the polyimide resin 3.

The composite material sheet 4 that is formed into a final product by the polyimide resin 3 being cured as described above is conveyed into the external drying oven 12, passing successively from the curing oven 13 to the exit 20 and the approximately 300° C. nitrogen gas curtain formed by the curtain nitrogen gas nozzle 25.

Then, the composite material sheet 4 reaches the gradual-cooling device 14 after passing through the drying oven 12 and is gradually cooled to a normal temperature by the gradual-cooling device 14. Stability of crystallization of the copper in the base material 2 is achieved. Flatness of the polyimide resin 3 and the base material 2 is maintained. As a result, a thin-film composite material sheet 4 having no curling can be produced. For example, the thickness of the copper thin film that is the base material 2 can be 9 micrometers to 25 micrometers. The thickness of the polyimide resin 3 can be about 10 micrometers to 25 micrometers. Moreover, the composite material sheet 4 is high in quality, having excellent heat resistance, weather resistance, flexibility, shape retention, peel strength, and the like.

The composite material sheet 4 is then wound by the winding device 6.

The present invention is not limited to the above-described embodiment. Various modifications can be made as required.

For example, the polyimide resin can be formed on both sides of the base material as the composite material sheet.

1. An apparatus for production of a composite material sheet including a resin thin-film layer formed by an organic solvent being cured on a base material by an organic solution composed of the organic solvent and a solvent being applied to a continuous base material, and the organic solution on the base material being dried and cured at a predetermined atmospheric temperature, the apparatus comprising:
a pre-heating means for drying by heating the base material coated with the organic solution and conveyed in a length direction until 10% to 15% of the solvent within the organic solvent remains;
a curing oven into which and from which the base material coated with the organic solution that is pre-heated by the pre-heating means is freely conveyed in a length direction of the base material;
an inert gas supplying means for holding the base material coated with the organic solution immediately before being conveyed into the curing oven within an inert gas atmosphere in the pre-heating means and preventing oxidation of the base material; and
a roll that winds a surface of the base material not coated with the organic solution to be dried and carries the base material into the curing oven, and heats the base material and the organic solution; an inert gas supplying means for forming an inert gas film between the roll and the base material, and maintaining the interior of the curing oven at a low oxygen concentration preventing oxidation of the base material; and a heating means for heating the organic solution applied to the base material wound around the roll to a temperature that is a glass transition point of the resin or higher and reducing a residual amount of solvent within the organic solvent to 1% or less (preferably 0.5%).

2. The apparatus for production of a composite material sheet according to claim 1, wherein the base material is a copper thin film, the resin is a polyimide resin, the inert gas is nitrogen gas, oxygen concentration in the inert gas supplying means section of the preheating means is 500 PPM to 1000 PPM, and the oxygen concentration within the curing oven is 100 PPM to 500 PPM.
